(19) United States
(12) Patent Application Publication
(10) Pub. No.: US 2008/0123953 A1
(43) Pub. Date: May 29, 2008

(54) Digital camera with histogram zoom

(75) Inventors: David W. Anderson, Sergeant Bluff, IA (US); Kenneth Walker, Trabuco Canyon, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/605,733

(22) Filed: Nov. 29, 2006

(51) Int. Cl. G06K 9/00

(52) U.S. Cl. 382/168

(57) ABSTRACT

An image capture system capable of displaying a representation of properties of pixels in a selected portion of a captured image. The inventive system comprises an image capturing device for capturing an image, a recording device for storing the captured image, a user interface configured to permit selecting a portion of the captured image, wherein the selected portion of the captured imaged is less than the entire captured image, a histogram display logic responsive to the properties of the pixels in the selected portion of the captured image, and a display device for displaying the captured image and simultaneously displaying the representation of properties of pixels of the selected portion of the captured image generated by the histogram display logic in a histogram display on a portion of the display device.

### FIELD OF THE INVENTION

The present invention relates to image capturing devices and more particularly to an improved use of the captured image histogram to determine the exposure parameters for the image capturing device.

### BACKGROUND OF THE INVENTION

Recently, digital cameras have become a very popular consumer appliance appealing to a wide variety of users ranging from photo hobbyists, web developers, real estate agents, insurance adjusters, photojournalists to everyday photography enthusiasts. Recent advances in large resolution charge coupled device (CCD) arrays and complementary metal oxide semiconductor (CMOS) image sensors coupled with the availability of low-power digital signal processors (DSPs) has led to the development of digital cameras that come quite close to the resolution and quality offered by traditional film cameras. These digital cameras offer several additional advantages compared to traditional film cameras in terms of data storage, manipulation, and transmission. The digital representation of captured images enables the user to easily incorporate the captured images into any type of electronic media and transmit them over any type of network. The ability to instantly view and selectively store captured images provides the flexibility to minimize memory waste and instantly determine if the captured image needs to be captured again. In its digital form the captured image can be corrected, altered, or modified after its capture.

Due to the varying scene brightness, to achieve a good overall image quality, it is necessary to control the exposure of the CCD or CMOS image sensor to maximize the dynamic range of the captured image. The main task of the exposure control circuitry is to keep the sensor operating in the optimal range by controlling the shutter speed, the aperture of the optical system, and the sensitivity of the sensor (commonly referred to as ISO).

When the image is captured by the image sensor, the image data from the image sensor is recorded on some type of recordable device. This recordable device may be a temporary storage location for processing the captured image data internal to the image capture device, or the recordable device may be a storage location for the captured image that is made available to the user of the image capture device. The recordable device can be relatively permanently incorporated into the camera or may be a type of removable storage. Also, the recordable device is typically rewritable; however some cameras may have a write once recordable device such as a compact disk (CD) recorder using CD recordable disks. Typical rewritable devices are internal RAM or flash RAM devices. Such flash RAM devices may have a variety of forms, including but not limited to: compact flash, memory stick, multimedia card, secure digital, and xD picture card. Other types of media could also be envisioned by those familiar in the field of digital cameras.

Digital cameras typically allow the photographer to review the captured images stored in the camera. The captured image is usually reviewed on a display on the rear of the camera; however, this could also be done through the viewfinder. The display is typically an LCD display although the particular technology of the display is not critical to the operation of the camera nor to the invention described below. To initiate the review of a captured image there is usually a button on the camera for the photographer to press to review the captured images. Some cameras automatically display the captured image immediately after the captured image has been captured. If the camera includes this feature, camera menus usually allow the setting of the length of time that the captured image is displayed after the capture of the captured image and whether the feature is enabled. When the photographer initiates a review of the captured images, typically left and right navigation buttons allow the photographer to move between the captured images (if any).

While reviewing a captured image, some cameras also offer the ability to zoom into any portion of the captured image. One reason for this is the display of the camera typically has a lower resolution than the image sensor of the camera, and thus not all the pixels of the captured image are capable of being shown by the display. Because of this, it may be beneficial for the photographer to zoom in on an area of the captured image for closer visual inspection. Displaying less than the entire captured image on the display may be referred to as zoom or digital zoom. The zoom is typically controlled by buttons on the back of the camera allowing the photographer to display a larger or a smaller portion of the captured image. While the displayed image is zoomed in on a portion of the captured image, the photographer may want to move to a different portion of the displayed image. This is typically done with left, right, up, and down navigation buttons or a joystick that functions as a left, right, up and down controller. Some cameras use the same left and right navigation buttons to move between captured images (when zoom is not being utilized) and moving to a different portion of the displayed image (when zoom is being utilized). Moving to a different portion of the displayed image is commonly referred to as panning.

Another method of selecting a portion of the captured image to display is to use a selection box. The selection box is superimposed on the displayed image and the selection box may be moved within the displayed image using the left, right, up and down navigation buttons or the joystick control. The size of the selection box may be controlled with the zoom in and zoom out buttons. Using the selection box, a portion of the displayed image may be selected then this selected portion may be displayed. The selection box method may be used in multiple iterations, each iteration selecting a portion of the displayed image. Using a selection box to select a portion of the captured image is well known and can be used as a user interface method to control the portion of the captured image that is displayed (zoom) or can be used to crop the captured image. Cropping the captured image removes the portion of the captured image that is not within the selection box.

Many current digital cameras have the ability to display a histogram of the entire captured image during display of the captured image. The display of the histogram of the entire captured image may be overlaid on the display of the captured image. A histogram is a graphical display of the count of pixels having a same property. The property may be a color, perceived brightness value, or another characteristic of the pixels used in evaluating the captured image. Each pixel in a digital image has a color which is produced by combination of the primary colors red, green, and blue (RGB). Each of these colors can have an intensity value. The overall perceived brightness of each pixel is determined by the intensity of each color component of the pixel. The perceived brightness is sometimes referred to as the luminance. The human eyes do not detect luminance linearly with color. The human eyes see green brighter than blue, so a formula to compute the luminance is needed. There are variations of this formula using different numbers for each color value. One possible formula is: Luminance value=0.3 R+0.59 G+0.11 B. The histogram can represent the luminance graphically with a range of luminance on the horizontal axis and the number of pixels on the vertical axis. FIG. 2 shows an example histogram 100. Such histograms are known in the prior art. The histogram 100 is a graphical display of the number of pixels depicted on the vertical axis 110 verses the luminosity level depicted on the horizontal axis 105. The range of the horizontal axis may be from 0 to 255, if an eight-bit per pixel sampling resolution is utilized. Other sampling rates such as 12 bits per pixel and 16 bits per pixel and even higher samples rates may be used. A sampling rate change may change the range of the horizontal axis of the histogram. The formula used to calculate the luminance value may also change the horizontal axis of the histogram.

Photographers typically use the histogram as a quick indicator of exposure and contrast of the picture. Generally, if the histogram is trending to the left, indicating a high number of darker pixels are present, then the exposure settings of the camera were set too low. Conversely if the histogram is trending toward the right, a high number of lighter pixels are present, then the exposure settings of the camera were set too high. Also, if the histogram shows many pixels at the left or right edge of the display these pixels are completely black or completely white and there is no photographical detail found in these pixels. The phenomenon of losing photographical data by pixels being completely black or completely white is typically referred to as clipping.

A histogram can illustrate whether a digital image is relatively dark or light and relatively high or low contrast, and what the distribution of data is within the image. The downfall of this method is that extremely bright and dark areas in a digital image cause the histogram to be shifted to the respective light or dark side. Also, when a digital image is represented by a histogram, all spatial information is lost. The histogram specifies the number of pixels having the,same property but gives no indication where these pixels are located in the image.

U.S. Pat. No. 6,486,915 describes making an image capture at a first exposure setting, determining if the histogram of the entire captured image is optimal and if not, changing the exposure settings and doing subsequent image captures until the histogram of the entire captured image is optimal. However, the method described in U.S. Pat. No. 6,486,915 does not take into account the contribution of each element or portion of the captured image to the histogram. For example a captured image with a bright sky may be underexposed, or too dark. The bright sky would create many pixels in the captured image with a high brightness value so bringing these to an optimal setting may result in the other elements of the captured image being too dark.

Metering is the term used when the camera is determining the exposure level to use when capturing an image. Metering options often include partial, evaluative zone or matrix, center-weighted and spot metering. Typically the built in light meter is a panel of semi-conductor light sensors that are sensitive to light energy. These sensors express this light energy as electrical energy. The metering system uses this electrical energy as a representation of the amount of light incident on the subject. The image sensor sensitivity to light, the shutter speed, and the aperture of the lens all affect the exposure of the captured image. A system using semi-conductor light sensors for metering is described in U.S. Pat. No. 5,146,258. A shortcoming of this method is the camera has a fixed number of discrete metering points or combination of points at which the subject is evaluated. Also, in-camera light meters have a fundamental flaw in that they can only measure reflected light. These in camera light meters thus can only provide an approximation of the light incident on the subject based on the amount of light reflected by the area the in camera light meter is sampling. If all objects reflected the same percentage of incident light, this approximation would be accurate. However, real-world subjects vary greatly in their reflectance. For this reason, in-camera metering is usually standardized based on the luminance of light which would be reflected from an object appearing as middle gray. If the camera is aimed directly at any object lighter or darker than middle gray, the camera's light meter may incorrectly calculate the exposure which may lead to the captured image being too light or too dark.

Having fixed light sensors reduces the ability to place the most important item in the photograph where the user desires. It is commonly known in photography that it is not good photograph composition practice to place the most important item (e.g. the primary subject) in the middle of the photograph. The common rule of thirds in photography states you should put the most important parts of the photograph a third of the way up or down, or a third of the way from one edge of the photograph. This helps produce nicely balanced captured images. If a light sensor is located at the center of the frame, the parts of the captured image in the center of the captured image may be exposed more correctly that other parts of the captured image. Because of the fixed location of light sensors the user may find it difficult to place the most important items of the captured image in the desired location.

U.S. Pat. No. 6,970,199 describes selecting a portion of the displayed images and providing a numerical value representative of the exposure information. The disadvantage of the method described in patent '199 is the user is presented with a single number representing all of the exposure information of the selected portion of the displayed image. The single number may not be sufficient information for the user to judge the quality of the photograph. One specific limitation is there is no contrast information conveyed in the number described in the '199 patent. Also, to make use of the information presented by the method described in the '199 patent, the photographer must have at least some knowledge of stops and percent scene reflectance. Non professional camera users typically do not understand, nor want to understand, stops and percent scene reflectance.

Typically digital cameras have several methods of exposure control. A first common method is keeping the aperture constant and changing the shutter speed to control the amount of light to the sensor. This method of exposure control is referred to as aperture priority. A second method is keeping the shutter speed constant and adjusting the aperture to control the amount of light to the sensor. This method of exposure control is referred to as shutter priority or time priority. The sensitivity of the sensor to light also affects the exposure. This is typically called effective ISO. Some digital cameras allow changing of the effective ISO setting of the camera's light sensor. The trade off of increasing the sensitivity of the light sensor to light is noise. The greater the sensitivity the more noise will be present in the captured image.

What is needed is a way to overcome the limitations of exposure control of digital image capture devices specifically in the area of light sensors, histogram display, and displaying the brightness of a selected portion of the captured image. The light sensors do not necessarily cover the area of interest that the user wants exposed correctly. The histogram only displays information for the entire captured image and may not show the data that the user needs to make exposure judgments of the captured image. The method in the prior art of presenting the user with exposure information for a selected portion of the captured image requires too much knowledge from the user and is limited in the amount of information conveyed by the single number.

### BRIEF SUMMARY OF THE INVENTION

In light of the foregoing, the present invention provides an image capture system capable of displaying a representation of properties of pixels in a selected portion of a captured image. The inventive system comprises an image capturing device for capturing an image, a recording device for storing the captured image, a user interface configured to permit selecting a portion of the captured image, wherein the selected portion of the captured imaged is less than the entire captured image, a histogram display logic responsive to the properties of the pixels in the selected portion of the captured image, and a display device for displaying the captured image and simultaneously displaying the representation of properties of pixels of the selected portion of the captured image generated by the histogram display logic in a histogram display on a portion of the display device.

This invention allows the user to select a portion of the captured image and displays a histogram of the selected portion of the captured image in some implementations, the selected portion of the captured image and the histogram display may be displayed simultaneously on the same display device.

This current invention overcomes the limitations of the prior art by allowing the photographer to select a portion of the captured image using a user interface and view a histogram of the selected portion of the captured image rather than being limited to using a histogram of the entire captured image, even though the photographer may not want the image to be limited to only the selected portion. Using this invention, the photographer would be able to ensure a selected portion of the captured image, such as the face of the subject, is correctly exposed.

This current invention overcomes the limitations of current metering systems by allowing setting of the exposure for the next capture using a selected portion of the captured image. This allows the photographer to select the area of interest that the camera will use to set the exposure or can guide the photographer as to how manual exposure settings should be adjusted.

### BRIEF DESCRIPTION OF THE SEVERAL VIEWS OF THE DRAWING

FIG. 1 shows a typical layout of the image display displaying a captured image with a histogram of the entire captured image in the upper left corner;

FIG. 2 shows a typical histogram showing a graphical representation of the number of pixels at each luminosity level;

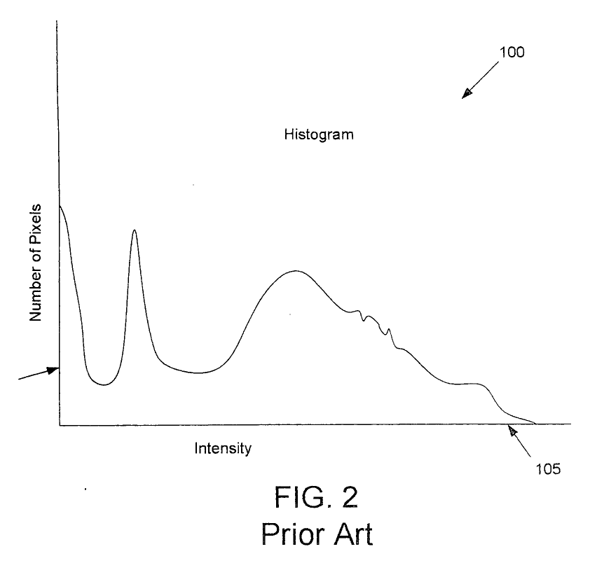

FIG. 3 shows a representation of the image display displaying a captured image and some controls on a digital camera;

FIG. 4 shows a larger view of the image display displaying a captured image on a digital camera;

FIG. 5 shows a layout of the image display displaying a captured image with a histogram of the selected portion of the captured image in the upper left corner and a selection box around a selected portion of the captured image, such as the subject's face.

FIG. 6 shows the image display zoomed to the selected portion of the captured image (e.g. around the subject's face) with the histogram displaying the number of pixels at each luminosity level of the selected portion of the captured image that is being displayed.

### DETAILED DESCRIPTION OF THE INVENTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

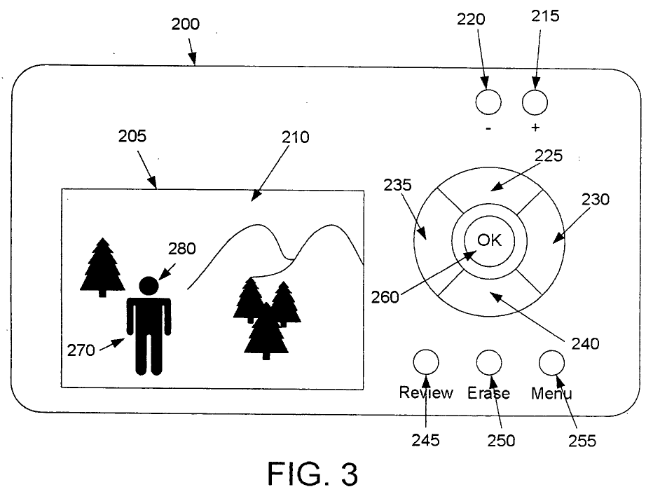

FIG. 3 shows an example of some controls typically found on a digital camera 200. After an image is captured, the user can review the captured image 210 on a display 205 on the rear of the camera 200. The review process may be initiated by pressing the review button 245, or selecting this option on an on screen menu. Pressing the review button 245 causes the captured image 210 to be displayed on the display 205 of the camera 200. Once the captured image 210 is displayed, the user may erase the captured image from the camera storage using the erase button 250. The user may more closely examine a portion of the captured image 210 by zooming in on the displayed image using the zoom in button 215 and conversely zooming out using the zoom out button 220. While the user is zoomed in on a portion of the displayed image 210 being displayed on the display 205, the entire captured image 210 will not fit on the display 205, so the ability to move the displayed portion of the captured image 210 shown on the display 205 may be helpful. Movement of the portion of the captured image 210 being displayed may be accomplished using the up button 225, down button 240, left button 235, and right button 230. Optionally the user may be able to control the zoom on a portion of the captured image 210 to a degree sufficient to display the constituent pixels of the captured image 210 on the display 205 where one pixel of the captured image 210 is displayed on one pixel of the display 205, rather than interpolated pixels sometimes used to display a large number of pixels on a display with a smaller number of pixels.

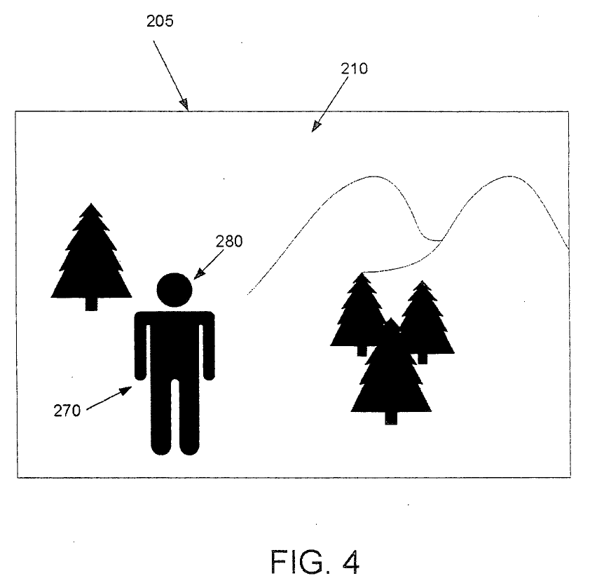

FIG. 4 shows an enlargement of the display 205 located on the rear of the camera 200, with a representation of a captured image 210 shown thereon. Illustratively, the captured image is a person with a landscape behind the person.

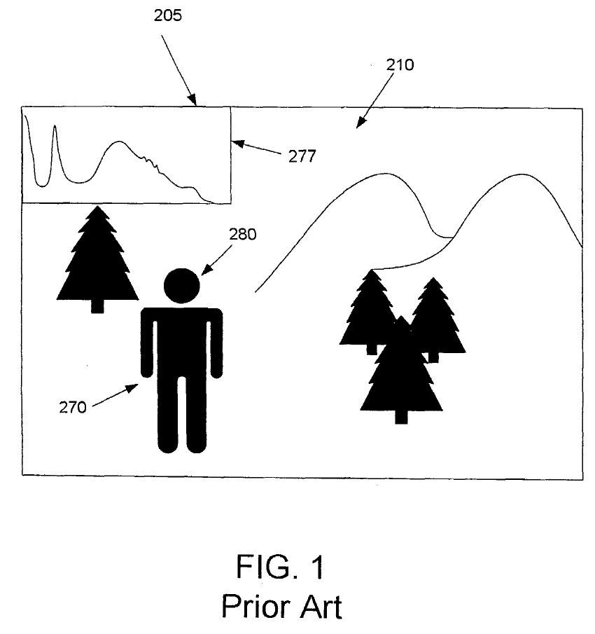

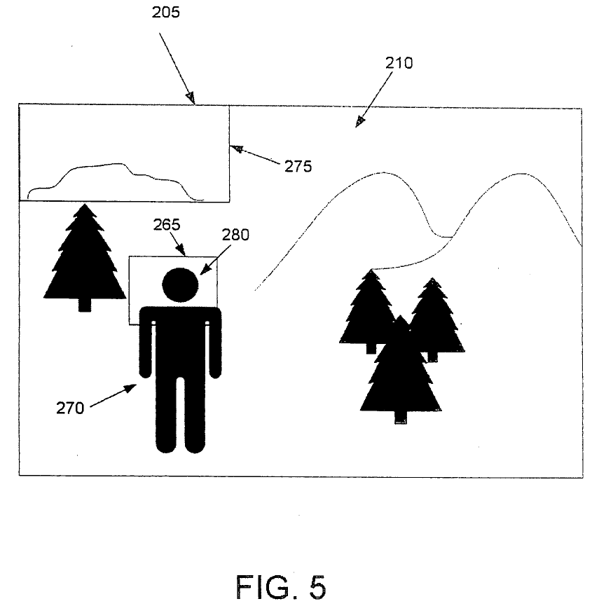

As noted above, not all portions of a captured image 210 are equally significant; however the histogram 277 of the entire captured image 210 (see FIG. 1) treats all portions equally. The present invention permits the user to select a portion of the entire captured image 210 and provides a histogram 275 that is based upon information contained only in the selected portion of the entire captured image 210 (in contrast to the histogram 277 that is based upon the information in the entire captured image). The selection of the portion of the captured image 210 to be included in the histogram 275 may be accomplished by, for example, zooming the displayed portion of the captured image 210 in on the desired portion of the captured image 210, so that the portion of the captured image 210 on which the histogram 275 is to be based is the portion of the captured image 210 that is displayed on the display 205, and the data represented in the histogram 275 is based only upon the selected portion of the captured image 210, and not the entire captured image 210. In other words, the selected portion is less than the entire captured image, and represents only a fraction of the entire captured image, so that the captured image includes a selected portion of the whole captured image and an unselected portion of the whole captured image. Another method of selecting a limited portion of the captured image 210 for basing the histogram 275 on is through the use of a selection box 265, such as is shown in FIG. 5. The selection box 265 may be superimposed on the displayed image 205 and the position of selection box 265 may be moved within the displayed portion of the captured image 210 using the left button 235, right button 230, up button 225 and down button 240. The histogram 275 on the display 205 displays a representation of the properties of the pixels in the selected portion of the captured image 210 bounded by the selection box 265. The size of the selection box 265 may be adjustable, and may be controlled with the zoom in button 215 and zoom out button 220. When the user is satisfied with the size and location of the selection box 265 (i.e., the portion of the captured image for which a histogram is desired is located within the selection box), the user can press the OK button 260 to cause a histogram 275 to be generated for the selected portion of the captured image 210. Prior to the OK button 260 being pressed, the histogram 275 may display the histogram 275 of the entire captured image 210, or the histogram 275 may display the histogram 275 of only the pixels within the selection box 265. Using the selection box 265, a portion of the captured image 210 on the image display 205 may be selected and then the selected portion may be enlarged to fill the entire, or substantially the entire, area of the display 205, although this is not necessary. The selection box method may be used in multiple iterations, each iteration selecting a smaller or larger or different sub-portion of the captured image 210.

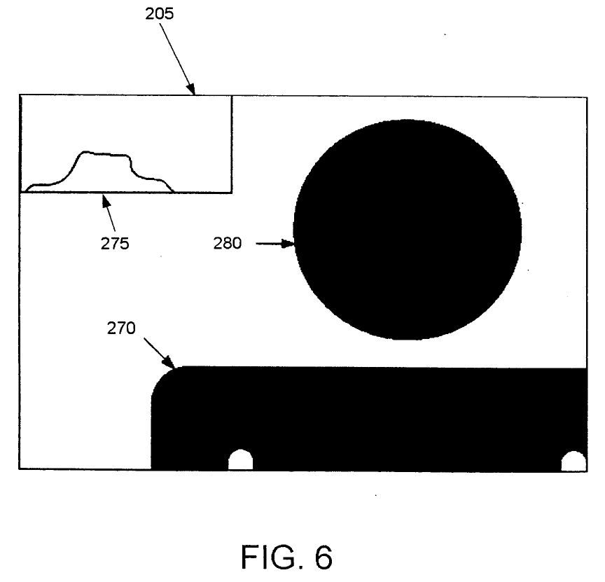

The user may thereby select the portion of the captured image 210 that is most important to the user, and then receive or view a histogram 275 of the selected portion or sub-portion of the captured image 210. The subject 270 of the captured image 210, shown in FIG. 3, is the person and in this captured image 210 the user may feel, for example, that the most important element to have exposed correctly is the subject's face 280. To ensure the subject's face 280 is correctly exposed, the invention allows the photographer to zoom in on a portion of the captured image 210 using the zoom in button 215, zoom out button 220 and the pan up button 225, pan down button 240, pan left button 235 and pan right button 230 until the desired portion, such as the subject's face 280, fills the display 205. See for example, FIG. 6. The display 205 is almost completely filled with the subject's face 280, and the histogram 275 on the display 205 represents the luminosities (or other characteristics) of the pixels representing the subject's face 280 (in the selected portion of the captured image 210). Viewing the histogram 275 of the selected portion of the captured image 210, such as the subject's face 280, the user can determine if the exposure of the captured image 210 is correct or needs to be adjusted. The user may then choose to make adjustment to the camera settings, such as shutter speed, aperture size, or equivalent ISO sensitivity, based upon the histogram 275 generated from the properties of the pixels in the selected portion of the captured image 210, rather than having to make such adjustments based upon a histogram 275 generated from the properties of all the pixels in the entire captured image 210.

In another embodiment of the invention, the image capture system automatically adjusts the image capture settings of the camera that affect the exposure of the next captured image to be captured based on the histogram 275 for the selected portion of the captured image 210. The method of adjusting the image capture settings affecting the exposure of the next captured image using the histogram 275 for the entire captured image 210 is known and is explained, for example, in U.S. Pat. No. 6,486,915, the disclosure of which is herein incorporated by reference. One of the advantages the present invention has over the '915 patent is that the present invention allows the user to select the portion of the captured image 210 that he or she considers the most significant and desires to have the correct exposure rather than being limited to the properties of all the pixels in the entire captured image 210 that determine the image capture settings affecting the exposure. The boundaries of the selected portion of the captured image are not limited to any particular size or shape within the captured image, and thus the resulting histogram 275 may reflect information about only a particular portion of the captured image that may be relatively small or relatively unrepresentative with respect to the entirety of the captured image.

The invention has been described in detail with particular reference to certain preferred embodiments thereof, but it will be understood that variations and modifications can be effected within the spirit and scope of the invention.

What is claimed is:

1. An image capture system capable of displaying a representation of properties of pixels in a selected portion of a captured image comprising:
an image capturing device for capturing an image;
a user interface configured to permit selecting a portion of the image captured by the image capturing device, wherein the selected portion of the captured imaged is less than an entirety of the captured image; and
a histogram display logic being responsive to properties of the pixels of the captured image located in the selected portion of the captured image and being unresponsive to properties of pixels of the captured image located outside of the selected portion, the histogram display logic being configured to generate a histogram representation of the properties of the pixels of the captured image located in the selected portion of the captured image without the properties of the pixels of the captured image located outside of the selected portion.

2. The image capture system of claim 1 additionally comprising a recording device for storing the captured image.

3. The image capture system of claim 1 additionally comprising a display device configured to display the captured image.

4. The image capture system of claim 3 wherein the display device is configured to display the histogram representation simultaneously with a section of the captured image.

5. The image capture system of claim 4 wherein the section of the captured image displayed with the histogram representation includes the selected portion of the captured image.

6. The image capture system of claim 5 wherein the section of the captured image displayed with the histogram representation includes a portion of the captured image outside of the selected portion.

7. The image capture system of claim 1, further including means for determining an exposure setting of a next image capture, is the exposure setting being at least partially responsive to information displayed by the histogram display for the selected portion of the captured image.

8. The image capture system of claim 1, wherein the user interface includes a zoom in control, a zoom out control, an up control, a down control, a left control, and a right control, said controls being configured to adjust a size of the selected portion of the captured image.

9. The image capture system of claim 1, wherein the user interface includes a zoom in control, a zoom out control, an up control, a down control, a left control, and a right control, said controls being configured to adjust a shape of the selected portion of the captured image.

10. The image capture system of claim 1, wherein the user interface includes a zoom in control, a zoom out control, an up control, a down control, a left control, and a right control, said controls being configured to adjust a location of the selected portion of the captured image within the captured image.

11. A method of evaluating pixel properties comprising the steps of:
a) capturing an image, the captured image having a plurality of pixels, each of the plurality of pixels having a property;
b) selecting a portion of the captured image wherein the selected portion of the captured image is less than the entire captured image;
c) generating a histogram based on the properties of the pixels located in the selected portion of the captured image without the properties of the pixels located outside of the selected portion of the captured image; and
d) displaying the histogram based on the property of the pixels of the selected portion of the captured image.

12. The method of claim 11 additionally comprising displaying the captured image on a display device.

13. The method of claim 12 additionally comprising displaying the selected portion of the captured image on the display device.

14. The method of claim 11 additionally comprising storing the captured image.

15. The method of claim 11 additionally comprising determining a set of image capture settings for an image capturing device based at least in part on the histogram generated based upon the properties of the pixels of the selected portion of the captured image.

16. The method of claim 15 additionally comprising capturing a second image using the set of image capture settings based on the property of the pixels of the selected portion of the captured image.

17. The method of claim 11 wherein selecting the portion of the captured image includes manipulating controls of a user interface on an image capturing device to indicate boundaries of the selected portion.

18. The method of claim 11 wherein selecting the portion of the captured image includes zooming in on a portion of the captured image to indicate boundaries of the selected portion.

19. The method of claim 11 wherein selecting the portion of the captured image includes moving sides of a frame superimposed on the captured image to indicate boundaries of the selected portion.
